(19) United States
(12) Patent Application Publication
(10) Pub. No.: US 2002/0026017 A1
(43) Pub. Date: Feb. 28, 2002

(54) Polymerization of copolymers of ethylene/propylene with higher olefins

(75) Inventors: Ioan Tincul, Sasolburg (ZA); Dawid Johannes Joubert, Sasolburg (ZA); Ignatius Hendrik Potgieter, Vanderbijlpark (ZA); Desmond Austin Young, Vanderbijlpark (ZA)

Correspondence Address: LADAS & PARRY, 26 WEST 61ST STREET, NEW YORK, NY, 10023, US

(73) Assignee: SASOL TECHNOLOGY (PTY) LIMITED

(21) Appl. No.: 09/863,829

(22) Filed: May 23, 2001

Related U.S. Application Data
(63) Continuation of application No. PCT/GB99/00241, filed on Jan. 25, 1999.

(30) Foreign Application Priority Data
Nov. 27, 1998 (ZA) 98/10887

(51) Int. Cl. C08F 4/44

(52) U.S. Cl. 526/124.3; 526/153; 526/348.2; 526/348.3

(57) ABSTRACT

A polymer obtained from a first olefin having fewer than 4 carbon atoms, and a second olefin having a total number of carbon atoms greater than 5 and having an uneven number of carbon atoms. The molar proportion of the first olefin to the second olefin in the polymer is from 90:10 to 99.9:0.1. A process for producing the polymer is also provided.

This invention relates to polymerization. More particularly, it relates to copolymers, and to a process for producing such copolymers.

According to a first aspect of the invention, there is provided a polymer obtained from a first olefin having fewer than 4 carbon atoms, and a second olefin having a total number of carbon atoms greater than 5 and having an uneven number of carbon atoms, with the molar proportion of the first olefin to the second olefin in the polymer being from 90:10 to 99.9:0.1.

According to a second aspect of the invention, there is provided a polymer which comprises a polymerization product obtained by polymerizing at least a first olefin having fewer than 4 carbon atoms and a second olefin having a total number of carbon atoms greater than 5 and having an uneven number of carbon atoms, with the molar proportion of the first olefin to the second olefin in the polymer being from 90:10 to 95.9:0.1.

The polymer may, in particular, be a copolymer of the first olefin with the second olefin.

According to a third aspect of the invention, there if provided a copolymer of a first olefin having fewer than 4 carbon atoms, and a second olefin having a total number of carbon atoms greater than 5 and having an uneven number of carbon atoms, with the molar proportion of the first olefin to the second olefin in the polymer being from 90:10 to 99.9:0.1.

The second olefin may be 1-heptene, 1-nonene, or 1-undecene, with 1-heptene and 1-nonene being preferred.

The olefins can be those obtained from a Fischer-Tropsch process; however, instead the olefins can be those obtained from another process provided that they are polymerizable, i.e. provided they can be polymerized with known catalysts.

The copolymers according to this invention are thermoplastic, and can readily be processed into articles by injection moulding, blow moulding, compression moulding, extrusion and thermoforming.

These copolymers have a high impact strength which increases with increasing content of the second olefin. On the other hand, tensile properties decrease moderately with an increase in the content of the second olefin in the copolymer; however, the tensile properties remain in the area of suitable application of articles obtained by the techniques mentioned hereinbefore.

The copolymers according to the invention may have:

a) a melt flow index, as measured according to ASTM D 1238, in the range of 0.01 to 50 dg/min; and

b) an Izod notched impact strength, as measured according to ASTM D 256, greater than 5 kJ/m²; and/or

c) a tensile strength at yield, as measured according to ASTM D 638 M, greater than 5 MPa; and/or

d) a modulus, as measured according to ASTM D 638 M, greater than 100 MPa.

The Applicant has ascertained that within the family of copolymers of the first olefin with the second olefin according to this invention, there are particular sub-families with surprising application properties. Thus, the sub-family of copolymers of ethylene with the second olefin have different application properties to the sub-family of copolymers of propylene with the second olefin.

In a first embodiment of the invention, the first olefin may be ethylene.

The copolymers according to the first embodiment of the invention may have:

a) a melt flow index, as measured according to ASTM D 1238, in the range of 0.01 to 50 dg/min; and

b) a density as measured according to ASTM D 1505, in the range of 0.90 and 0.950 gm/cm³; and/or

c) an Izod notched impact strength, as measured according to ASTM D 256, greater than 5 kJ/m²; and/or

d) a tensile strength a yield, as measured according to ASTM D 638 M, greater than 5 MPa; and/or

e) a modulus, as measured according to ASTM D 638 M, greater that 100 MPa.

The Applicant has surprisingly found that within the sub-family of copolymers of ethylene with the second olefin as obtained according to this invention, there are particular groups with even more surprising application properties. Thus, copolymers of ethylene with 3-heptene as the second olefin have surprisingly been found to have different application properties to copolymers of ethylene with 1-nonene as the second olefin. These properties cannot be correlated to a mathematical relationship between the carbon numbers of the respective second olefins.

Thus, in one version of the first embodiment of the invention, there is provided a copolymer of ethylene with 1-heptene.

A preferred content of heptene in the copolymer of ethylene with 1-heptene according to this invention, is between 0.2 mol percent and 2 mol percent.

The copolymer of ethylene and 1-heptene according to this invention may have:

a) a melt flow, index as measured according to ASTM D1238, in the range of 0.01 to 50 dg/min; and/or

b) a density as measured according to ASTM D 1505, in the range of 0.910 and 0.950 gm/cm²; and/or

c) an Izod notched impact strength, I, as measured according to ASTM D 256, which complies with the following equation:

I>10[C₇]

where [C₇] is the molar concentration of 1-heptene in the polymer, and/or

d) a tensile strength at yield, σ, as measured according to ASTM D 638 M, which complies with the following equation:

σ>−4.4[C₇]+17;

and/or

e) a modulus, E, as measured according to ASTM D 638 M, which complies with the following equation:

E>−275[C₇]+850;

and/or

f) a hardness, H, as measured according to ASTM D 2240, which complies with the following equation;

H>−10[C₇]+56

In another version of the first embodiment of the invention, there is provided a copolymer of ethylene with 1-nonene.

A preferred content of 1-nonene in the copolymer of ethylene with 1-nonene according to this invention, is between 0.1 mol percent and 1.5 mol percent.

The copolymer of ethylene and 1-nonene according to this invention may have:

a) a melt flow index, as measured according to ASTM D 1238, in the range of 0.01 to 50 dg/min, and/or

b) a density a measured according to ASTM D 1505, in the range of 0.910 and 0.950 gm/cm³; and/or

c) an Izod notched impact strength, I, as measured according to ASTM D 256, which complies with the following equation:

I>13.3[C₉]

where [C₉] is the molar concentration of 1-nonene; and/or

d) a tensile strength at yield, σ, as measured according to ASTM D 638 M, which complies with the following equation:

σ>−16.67[C₉]+25;

and/or

e) a modulus, E, as measured according to ASTM D 638 M, which complies with the following equation:

E>−666.67[C₉]+1100;

and/or

f) a hardness, H, as measured according to ASTM D 2240, which complies with the following equation:

H>−30[C₉]+65

In a second embodiment of the invention, the first olefin may be propylene.

The Applicant has surprisingly found that within the sub-family of copolymers of propylene with the second olefin as obtained according to this invention, there are particular groups with even more surprising application properties. Thus, copolymers of propylene with, 1-heptene as the second olefin have surprisingly been found to have different application properties to copolymers of propylene with 1-nonene as the second olefin. The changes in the values of the application properties cannot be correlated to a mathematical relationship between the carbon numbers of the respective second olefins.

Thus, in one version of the second embodiment of the invention, there is provided a copolymer of propylene with 1-heptene.

A preferred content of 1-heptene in the copolymer of propylene and 1-heptene according to this invention, is between 0.2 mol percent and 2 mol percent.

The copolymer of propylene and 1-heptene according to this invention may have;

a) a melt flow index as measured according to ASTM D 1238, in the range of 0.01 to 50 dg/min; and/or

b) an Izod notched impact strength, I, as measured according to ASTM D 256, which complied with the following equation:

I>7.5[C₇]

where [C₇] is the polar concentration of 1-heptene in the polymer; and/or

c) a tensile strength at yield, σ, as measured according to ASTM D 638 M, which complies with the following equation:

σ>−7[C₇]+24;

and/or

d) a modulus, E, as measured according to ASTM D 638 M, which complies with the following equation:

E>−350[C₇]+1000

and/or

e) a hardness, H, as measured according to ASTM D 2240, which complied with the following equation:

H>−7.2[C₇]+63

In another version of the second embodiment of the invention, there is provided a copolymer of propylene with 1-nonene.

A preferred content of 1-nonene in the copolymer of propylene and 1-nonene according to this invention, is between 0.1 mol percent and 1.5 mol percent.

The copolymer of propylene and 1-nonene according to this invention may have;

a) a melt flow index as measured according to ASTM D1238, in the range of 0.01 to 50 dg/min; and/or

b) an Izod notched impact strength, I, as measured according to ASTM D 236, which complies with the following equation:

I>15[C₉]

where [C₉] is the molar concentration of 1-nonene in the polymer; and/or

c) a tensile strength at yield, σ, an measured according to ASTM D 638 M, which complies with the following equation:

σ>−5.3[C₉]+24;

and/or

d) a modulus, E, as measured according to ASTM D 638 M, which complies with the following equation:

E>−333.3[C₉]+1000;

and/or

e) a hardness, E, as measured according to ASTM D 2240, which complies with the following equation:

H>−6.67[C₉]+65

In particular, the copolymers may be obtained by reacting the first olefin with the second olefin in one or more reaction zones, while maintaining in the reaction zone(s) a pressure in the range between atmospheric and 200 kg/cm² and a temperature between ambient and 300° C., in the presence of a suitable catalyst or catalyst system.

The Applicant has also found that in the copolymerization of the first olefin with the second olefin, specific and different copolymers are obtained when different specific process conditions are employed.

Thus, according to a fourth aspect or the invention, there is provided a process for producing a polymer, which process comprises reacting a reaction mixture comprising, as a first monomer, a first olefin having fewer than 4 carbon atoms and, as a second monomer, a second olefin having a total number of carbon atoms greater than 5 and having an uneven number of carbon atoms, in one or more reaction zones, while maintaining the reaction zone(s) at a pressure between atmospheric pressure and 200 kg/cm², and at a temperature between ambient and 300° C., in the presence of a catalyst system or a catalyst system comprising a catalyst and a cocatalyst, such that the molar proportion of the first olefin to the second olefin in the resultant polymer is from 90:10 to 99.9:0.1.

The reaction zone(s) may be provided in a single stage reactor vessel or by a chain of two or more reaction vessels.

Copolymers obtained from the process by using a particular feed composition and under particular reaction conditions have a random distribution which is determined mainly by the different reactivities of the monomers. This provides a unique tool for obtaining a large variety of copolymers of the first olefin with the second olefin, whose properties are mainly controlled by their composition and non-uniformity.

The molecular weight of the resultant random copolymer can be regulated by hydrogen addition to the reaction zone(s) during the reaction. The greater the amount of hydrogen added, the lower the molecular weight of the random copolymer.

The copolymerization is preferably performed in a substantially oxygen and water free state, and may be effected in the presence or absence of an inert saturated hydrocarbon

The copolymerization reaction may be carried out in a slurry phase, a solution phase or a vapour phase, with slurry phase polymerization being preferred.

When slurry phase polymerization is used, the catalyst will be in solid form, and preferably comprises a Ziegler-Natta catalyst. A catalyst system comprising a titanium based Ziegler-Natta catalyst and, as cocatalyst, an organo aluminum compound, is preferred. Thus, the comonomers will be polymerized in a suspension state in the presence of the Ziegler-Natta catalyst which is in solid form and suspended in a slurrying or suspension agent.

When vapour phase polymerization is used, the catalyst may also be in solid form, and preferably comprises a Ziegler-Natta catalyst. Move particularly a silica supported catalyst or a prepolymerized catalyst of a polymer diluted catalyst may then be used. A catalyst system comprising a titanium based Ziegler-Natta catalyst and, as cocatalyst, an organo aluminium compound, is preferred. Most preferred is a prepolymerized titanium catalyst ad a polymer diluted titanium catalyst.

In a first embodiment of this aspect of the invention, ethylene may be copolymerized with 1-heptene or 1-nonene. The Applicant has found that in the copolymerization of ethylene with 1-heptene or 1-nonene, particular and different copolymers are obtained when different specific process conditions are employed.

Any Ziegler-Natta catalyst suitable for ethylene copolymerization may, at least in principle, be used. Catalysts normally used for the copolymerization of ethylene with other olefins are preferred. However, the most preferred catalysts for the copolymerization of ethylene and 1-heptene or 1-nonene are magnesium chloride supported titanium catalysts, as hereinafter described.

Thus, in the preferred catalysts, magnesium chloride is the catalyst support. The magnesium chloride may be used in the form of anhydrous magnesium chloride, or may have a water content between 0.02 mole of water/1 mole of magnesium chloride and 3 mole of water per 1 mole of magnesium chloride, i.e. it may be partially anhydrized. Most preferably, when the magnesium chloride is partially anhydrized, the water content of the magnesium chloride being, in one particular case, 1.5%, and, in a second particular case, 5% by mass.

The anhydrous or partially anhydrized magnesium chloride in preferably activated prior to contacting or loading it with the titanium tetrachloride.

The activation of the magnesium chloride may be performed under inert conditions, i.e. in a substantially oxygen and water free atmosphere, and in the absence or in the presence of an inert saturated hydrocarbon liquid. Preferred inert saturated hydrocarbon liquids are aliphatic or cyclo-aliphatic liquid hydrocarbons, of which the most preferred are hexane and heptane.

The magnesium chloride or support activation may be performed in two steps designated (a₁) and (a₂) respectively.

In step (a₁), a complexing agent is added under inert conditions to a suspension of the magnesium chloride in the inert hydrocarbon liquid or to the magnesium chloride in powder form. The complexing agent may be selected from the class of an alcohol or a mixture of an alcohol and an ether. Each different alcohol, alcohol mixture, or alcohol mixture with an ether or with different ether, will give a particular catalyst having different performance.

The alcohol may be a linear or branched alcohol with a total number of carbon atoms between 2 and 16. It is preferred to use a mixture of alcohols, with the most preferred being mixtures of linear and branched alcohols. When a linear alcohol is used, between 0.02 mole of alcohol/1 mole of magnesium chloride and 2 mole of alcohol/per 1 mole of magnesium chloride, may be used. When a branched alcohol or a mixture of linear and branched alcohols is used, between 0.015 mole of alcohol/mole of magnesium chloride and 1.5 mole of alcohol/mole of magnesium chloride, may be used. The ether may be an ether with a total carbon number, is a total number of carbon atoms, of 8 to 16. Either a single ether or a mixture of ethers can be used. When mixtures of linear alcohols and ethers are used, between 0.01 mole of alcohol/ether mixture per 1 mole of magnesium chloride and 2 mole of alcohol/ether mixture per 1 mole of magnesium chloride, may be used. Most preferred are mixtures of branched alcohols and ethers, in which case between 0.05 mole of alcohol/ether mixture per 1 mole of magnesium chloride end 1.5 mole of alcohol/ether mixture per 1 mole of magnesium chloride, may be used.

The Applicant has surprisingly found that by using different complexing agents, catalyst with different performances are obtained. Thus, when a mixture of a branched alcohol and an ether in used, the productivity of the catalyst is higher than when a mixture of a linear alcohol and an ether is used. When an alcohol alone is used alone, the productivity was found to be lower than when a mixture of an alcohol with an ether is used. Branched alcohols, when used alone, gave higher productivities than linear alcohol.

The resultant mixture or suspension may be stirred for a period of 10 minutes to 24 hours at room temperature. The preferred stirring time is 1 to 12 hours. The preferred temperature for preparing the partially activated magnesium chloride is 40° C. to 140° C. A partially activated magnesium chloride is thus obtained.

In the second step (a₂), an alkyl aluminium compound is added, preferably in dropwise fashion, to the partially activated magnesium chloride. Typical alkyl aluminium compounds which can be used are those expressed by the formula AlR₃ wherein R is an alkyl radical or radical component of 1 to 10 carbon atoms. Specific examples of suitable alkyl aluminium compounds, which can be used, are: tri-butyl aluminium, tri-isobutyl aluminium, tri-hexyl aluminium and tri-octyl aluminium. The preferred organo-aluminium compound is tri-ethyl aluminium. The molar ratio of the alkyl aluminium compound to the anhydrous or partially anhydrized magnesium chloride initially used may be between 1:1 and 6:1. The preferred molar ratio of the alkyl aluminium compound to the magnesium chloride is 4:1 to 5:1.

The loading of the activated magnesium chloride or support with the titanium tetrachloride may be performed in two steps, designated (b₁) and (b₂) respectively.

In the first step (b₁), to the support, after thorough washing thereof with hexane, is added an alcohol under stirring. The activated support may be in the form of a suspension in an inert saturated hydrocarbon liquid, as hereinbefore described. The alcohol may be selected from the range of alcohols having 2 to 8 carbon atoms. A dicomponent alcohol mixture can be used. The most preferred method is to use a dicomponent alcohol mixture comprising two alcohols having, respectively, the same number of carbon atoms as the two monomers used in the process of polymerization wherein the catalyst, the product of this catalyst preparation, is used.

The molar ratio of the alcohol mixture to the initial magnesium chloride used may be between 0.4:1 and 4:1. However, the preferred molar ratio of the alcohol mixture to the initial magnesium chloride is 0.8:1 to 2.5:1.

The molar ratio between the two alcohols in a dicomponent mixture can be from 100:1 to 1:100. However, the preferred molar ratio between the two alcohols is 1:1.

The stirring time may be between 1 min and 10 hours, preferably about 3 hours.

The temperature during the stirring can be between 0° C. and the lowest boiling point of any one of the alcohols in the multicomponent mixture or the inert saturated hydrocarbon liquid when used in this step of the catalyst preparation.

In the second step (b₂), titanium chloride, TiCl₄, is added to the support/alcohol mixture, the resultant mixture or slurry stirred under reflux, and finally left to cool, e.g. for about 24 hours. The catalyst obtained may be thoroughly washed, e.g. with hexane.

The molar ratio of TiCl₄ employed in this step to the initial magnesium chloride may be from about 2:1 to about 20:1, preferably about 10:1.

When a cocatalyst is employed in the polymerization, it may, as stated hereinbefore, be an organo aluminium compound. Typical organo-aluminium compounds which can be used are compounds expressed by the formula AlRₘX₃₋ₘ wherein R is a hydrocarbon component of 1 to 15 carbon atoms, X is a halogen atom, and m is an integer represented by 0<m<3. Specific examples of suitable organo aluminium compounds that can be used are a trialkyl aluminium, a trialkyl aluminium, a partially halogenated alkyl aluminium, an alkyl aluminium sesquihalide, an alkyl aluminium dihalide. Preferred organo aluminium compounds are alkyl aluminium compounds, and the most preferred compound is triethylaluminium. The atomic ratio of aluminium to titanium in the catalyst system may be between 0.1:1 and 500:1, preferably between 1:1 and 100:1.

For slurry phase copolymerization, preferred slurrying or suspension agents are aliphatic or cyclo-aliphatic liquid hydrocarbons, with the most preferred being hexane and heptane.

While the reaction temperature can be in the range of ambient to 200° C., it is preferably in the range of 50° C. to 100° C. and most preferably in the range of 60° C. to 90° C.

While the pressure can be in the range of atmospheric pressure to 200 kg/cm², it is preferably in the range of 3 kg/cm² to 30 kg/cm², still more preferably in the range of 4 kg/cm² to 18 kg/cm².

When using a catalyst prepared in accordance with the catalyst preparation process hereinbefore described, the parameters of the copolymerization reaction of ethylene with 1-heptene or 1-nonene are thus such that the resultant copolymer of ethylene with 1-heptene or 1-nonene is as hereinbefore described.

In another embodiment of this aspect of the invention, propylene may be copolymerized with 1-heptene or 1-nonene. The Applicant has found that in the copolymerization of propylene with 1-heptene or 1-nonene, particular and different copolymers are obtained when different specific process conditions are employed.

Any Ziegler-Natta catalyst suitable for propylene copolymerization, at least in principle, may be used. Catalysts used for the copolymerization of propylene with other olefins are preferred.

Typical titanium components of Ziegler-Natta catalysts suitable for propylene copolymerization are titanium trichloride and titanium tetrachloride, which may be carried on a support. Catalyst support and activation can be effected in known fashion. For the preparation of the titanium catalyst, halides or alcoholates of trivalent or tetravalent titanium can be used. In addition to the trivalent and tetravalent titanium compounds, and the support or carrier, the catalyst can also contain electron donor compound, e.g. mono or polyfunctional carboxyl acids, carboxyl anhydrides and esters, ketones, ethers, alcohols, lactones, or phosphorous or organic silicon compounds.

An example of a preferred titanium-based Ziegler-Natta catalyst is TiCl₃.AlCl₃.(n-propyl benzoate), which is commercially available.

However, most preferred catalysts for the copolymerization of propylene with 1-heptene or 1-nonene are titanium tetrachloride catalysts magnesium chloride supported, as hereinafter described.

Thus, in the preferred catalysts, magnesium chloride is the catalyst support. The magnesium chloride may be used in the form of anhydrous magnesium chloride, or may have a water content between 0.02 mole of water/1 mole of magnesium chloride and 2 mole of water per 1 mole of magnesium chloride, i.e. it may be partially anhydrized. Most preferably, when the magnesium chloride is partially anhydrized, the water content of the magnesium chloride is, in one particular case, 1.5%, and, in a second particular case, 5% by mass.

The magnesium chloride is preferably activated prior to contacting or leading it with the titanium tetrachloride.

The activation of the magnesium chloride may be performed under inert conditions, i.e. in a substantially oxygen and water free atmosphere, and in the absence or in the presence of an inert saturated hydrocarbon liquid. Preferred inert saturated hydrocarbon liquids are aliphatic or cyclo-aliphatic liquid hydrocarbons, of which the most preferred are hexane and heptane.

The magnesium chloride or support activation my be performed in two steps, designated (a₁) and (a₂) respectively.

In step (a₁), a complexing agent, is added under inert conditions to a suspension of the magnesium chloride in the inert hydrocarbon liquid or to the magnesium chloride in powder form. The complexing agent may be selected from the class of an alcohol or a mixture of an alcohol and an ether.

The alcohol may be a linear or branched alcohol with a total number of carbon atoms between 2 and 16. It is preferred to use a mixture of alcohols, with the most preferred being mixtures of linear and branched alcohols. When a linear alcohol is used, between 0.02 mole of alcohol/1 mole of magnesium chloride and 2 mole of alcohol/per 1 mole of magnesium chloride, may be used. When a branched alcohol or a mixture of linear and branched alcohols is used, between 0.015 mole alcohol/mole of magnesium chloride and 1.5 mole of alcohol/mole of magnesium chloride, may be used. The ether may be an ether with a total carbon number of 8 to 16. Either a single ether or a mixture of ethers can be used. When mixtures of linear alcohols and ethers are used, between 0.01 mole of alcohol/ether mixture per 1 mole of magnesium chloride and 2 mole of alcohol/ether mixture per 1 mole of magnesium chloride may be used. Most preferred are mixtures of branched alcohols and ethers, in which case between 0.015 mole of alcohol/ether mixture per 1 mole of magnesium chloride and 1.5 mole of alcohol/ether mixture per 1 mole of magnesium chloride, may be used.

In the second step (a₂), an alkyl aluminium compound is added, preferably in dropwise fashion, to the partially activated magnesium chloride obtained in step (a₁). Typical alkyl aluminium compounds which can be used are those expressed by the formula AlR₃ wherein R is an alkyl radical or radical component of 1 to 10 carbon atoms. Specific examples of suitable alkyl aluminium compounds that can be used are: tri-butyl aluminium, tri-isobutyl aluminium, tri-hexyl aluminium and tri-octyl aluminium. Preferred organo-aluminium compounds are diethylaluminium chloride, and tri-ethyl aluminium. The molar ratio of the alkyl aluminium compound to the anhydrous or partially anhydrized magnesium chloride initially used may be between 1:1 and 6:1. The preferred molar ratio of the alkyl aluminium compound to the magnesium chloride is 4:1 to 5:1. More particularly, the amount of the aluminium alkyl added to the partially activated magnesium chloride may comply with the equation:

A>B+C+D

where A represents total moles of aluminium alkyl, while B are mole of magnesium chloride, C are total moles of alcohol or ether/alcohol mixture and D are total moles of water (as the sum of total water present in the magnesium chloride and eventual traces of water in the solvent).

The loading of the activated magnesium chloride or support with the titanium tetrachloride may be performed in three steps, designated (b₁)(b₂) and (b₃) respectively.

In the first step (b₁), to the support, after thorough washing thereof with hexane, is added, under stirring, a first ester component comprising an ester. The activated support may be in the form of a suspension in an inert saturated hydrocarbon liquid, as hereinbefore described. The ester may be selected from the close of organic esters derived from an aromatic acid, a diacid or an aromatic anhydride. The Applicant has surprisingly found that different performances of the catalyst are obtained if specific esters are used in this step of the catalyst preparation. Thus, preferred esters are esters derived from benzoic acid, phthalic acid ad trimellitic anhydride. A particularly preferred ester is that where the ester is derived from a dibasic aromatic acid esterified with two different alcohols.

In one version of this embodiment of the invention, a single ester may be used as a first ester component. In another version of this embodiment of the invention, a Mixture of esters may be used an the first ester component. In an even more particular case, a tricomponent ester mixture may be used as the first eater component.

The molar ratio of the first ester component to the initial magnesium chloride used may be between 0.05:1 and 5:1.

The molar ratio between the two esters in a dicomponent mixture can be from 100:1 to 1:100.

The molar ratio between the esters in a three component ester mixture can vary widely, but preferably is about 1:1:1.

The stirring time may be between 1 min and 10 hours, preferably about 3 hours.

The temperature during the stirring can be between 0° C. and the lowest boiling point of any one of the esters in the multicomponent mixture or the inert saturated hydrocarbon liquid when used in this step of the catalyst preparation.

In the second step (b₂), titanium chloride, TiCl₄, is added to the support/ester mixture, the resultant mixture or slurry stirred under reflux, and finally left to cool, e.g. for about 24 hours. The catalyst obtained may be thoroughly washed, e.g. with hexane.

The molar ratio of TiCl₄ employed in this step to the initial magnesium chloride may be from about 2:1 to about 20:1, preferably about 10:1.

In the third step (b₃) a second eater component comprising an ester is added. In this step (b₃), two cases can be distinguished, both surprisingly resulting in catalysts with different performances:

i) The second ester component is the same as the first ester;

ii) The second ester component is different to the first ester component.

The Applicant has also surprisingly found that a very different family of catalysts may be obtained when a particular manner of the titanium chloride loading is used and which may lead to different and advantageous process performance when used in the different embodiments and versions of this invention.

Thus, in one version of this embodiment of the invention, the order of loading of the titanium chloride may be: adding the titanium chloride to the activated support as in step (b₂), followed by adding the electrodonor as in step (b₁), and followed by adding again the titanium chloride as in step (b₂). Thus, the order of titanium chloride loading on the activated support is steps (b₂)-(b₁)-(b₂). In this particular method of catalyst preparation, step (b₁) and step (b₂) are followed by thorough washing with heptane at a temperature just below boiling.

When a cocatalyst in employed in the polymerization it may, as stated hereinbefore, be an organo aluminium compound. Typical organo-aluminium compounds which can be used are compounds dressed by the formula AlRₘX₃₋ₘ wherein R is a hydrocarbon component of 1 to 15 carbon atoms, X is a halogen atom, and m is an integer represented by 0<m≦3. Specific examples of suitable organo aluminium compounds that can be used are: a trialkyl aluminium, a trialkenyl aluminium, a partially halogenated alkyl aluminium, an alkyl aluminium sesquihalide, an alkyl aluminium dihalide. Preferred organo aluminium compounds are alkyl aluminium compounds, and the most preferred compound is triethylaluminium. The atomic ratio of aluminium to titanium in the catalyst system may be between 0.1:1 and 500:1, preferably between 1:1 and b 100:1.

For slurry phase copolymerization preferred slurrying or suspension agents are aliphatic or cyclo-aliphatic liquid hydrocarbons, with the most preferred being hexane and heptane.

While the reaction temperature can be in the range of ambient to 300° C., it is preferably in the range of 50° C. to 100° C., and most preferably in the range of 60° C. to 90° C.

While the pressure can be in the range of atmospheric pressure to 200 kg/cm², it is preferably in the range of 3 kg/cm² to 30 kg/cm², still more preferably in the range of 4 kg/cm² to 18 kg/cm².

When using a catalyst prepared in accordance with the catalyst preparation process hereinbefore described, the parameters of the copolymerization reaction of propylene with 1-heptene or 1-nonene are thus such that the resultant copolymer of propylene with 1-heptene or 1-nonene as hereinbefore described.

The invention will now be described in more detail with reference to the following non-limiting example. In these examples, the composition of the copolymers was determined by ¹³C NMR. The following ASTM tests were used to determine the properties of the polymers in the examples: melt flow index—ASTM D 1238; tensile strength at yield—ASTM D 638 M; Young's modulus ASTM D 638 M; hardness—ASTM D 2240; Izod impact strength—ASTM 2567 density—ASTM D 1505; and hardness—ASTM D 3340.

### EXAMPLE 1

Catalyst A Preparation

In a 250 ml flask equipped with a reflux condenser and stirring facilities 2 g of magnesium chloride with a total water content of 1.5% by mass was suspended in 60 ml highly purified hexane. 4 ml of a 1:1 molar mixture of dipentyl ether and ethanol were added to the flask, and the mixture stirred for 3 hours under reflux. The mixture was allowed to cool to ambient temperature, and 10 g of tri-ethyl aluminum were added dropwise to avoid excessive heat build-up. The resultant slurry was allowed to cool to room temperature under stirring and then subjected to twelve washings using 50 ml hexane each time, to obtain an activated support-containing slurry.

To the activated support-containing slurry were added 2 ml of a 1:1 molar mixture of ethanol and 1-nonanol, and the slurry stirred for 3 hours at ambient temperature. 15 ml of TiCl₄ was then added, and the mixture stirred under reflux for 2 hours. After cooling down, the slurry was subjected to ten washing using 50 ml hexane each time and then dried.

Copolymerization

To a thoroughly cleaned 1 liter autoclave fitted with stirring and heating/cooling facilities and flushed with nitrogen, was added 350 g heptane and the temperature set at 85° C. A catalyst system, comprising 0.2 g of catalyst A and 10 ml of a 10% solution of tri-ethyl aluminium in heptane, was added and reacted under stirring in the presence of 150 mg hydrogen for 5 minutes to activate the catalyst. Simultaneous flows of ethylene and 1-nonene at 10 and 2.5 g/min respectively were thereafter commenced. After 10 minutes the ethylene and 1-nonene feeds were stopped, and the reaction continued for another 50 minutes. The reactor was depressurized and the catalyst deactivates by the addition of 100 ml isopropanol. The slurry wag filtered and tie polymer washed with acetone and dried under vacuum at 80° C. The yield of copolymer containing 0.3 mol % 1-nonene and with a melt flow index of 1.5 dg/minutes was 105 g. The polymer had the following properties:

| | |
|---|---|
| Tensile strength at yield | 22.4 MPa |
| Young's modulus | 967 MPa |
| Hardness | 61 |
| Izod Impact strength | 9.7 kJ/m² |
| Density | >0.943 g/cc |

### EXAMPLE 2

Catalyst B Preparation

In a 250 ml flask equipped with a reflux condenser and stirring facilities, 2 g of magnesium chloride with a total water content of 1.5% by mass was suspended in 60 ml highly purified hexane. 4 ml of a 1:1 molar mixture of dipentyl ether and isopentanol were added to the flask, and the mixture stirred for 3 hours under reflux. The mixture was allowed to cool to ambient temperature, and 10 g of tri-ethyl aluminium were added dropwise to avoid excessive heat build-up. The resultant slurry was allowed to cool to room temperature under stirring and then subjected to twelve washings using some hexane each time, to obtain an activated support-containing slurry.

To the activated support-containing slurry were added 2 ml of a 1:1 molar mixture of ethanol and 1-heptanol, and the slurry stirred for 3 hours at ambient temperature. 15 ml of TiCl₄ was then added, and the mixture stirred under reflux for 2 hours. After cooling down, the slurry was subjected to ten washing using 50 ml hexane each time and then dried.

Copolymerization

To a thoroughly cleaned 1 liter autoclave fitted with stirring and heating/cooling facilities and flushed with nitrogen, was added 350 g heptane and the temperature set at 85° C. A catalyst system, comprising 0.2 g of catalyst B and 10 ml of a 10% solution of tri-ethyl aluminium in heptane, was added and reacted under stirring in the presence of 100 mg hydrogen for 5 minutes to activate the catalyst, simultaneous flows of ethylene and 1-nonene at 10 and 5 g/min respectively were thereafter commenced. After 10 minutes the ethylene and 1-nonene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 0.9 mol % 1-nonene with a melt flow index 0.4 dg/minute was 135 g. The polymer had the following properties:

| | |
|---|---|
| Tensile strength at yield | 17.7 MPa |
| Young's modulus | 535 MPa |
| Hardness | 51 |
| Izod Impact strength | 50.75 kJ/m² |
| Density | 0.9287 g/cc |

### EXAMPLE 3

Catalyst A1 Preparation

In a 250 ml flask equipped with a reflux condensed and stirring facilities, 2 g of magnesium chloride with a total water content of 1.5% by mass was suspended in 60 ml highly purified hexane. 4 ml of ethanol were added to the flask, and the mixture stirred for 3 hours under reflux. The mixture was allowed to cool to ambient temperature, and 10 g of tri-ethyl aluminium were added dropwise to avoid excessive heat build-up. The resultant slurry was allowed to cool to room temperature under stirring and then subjected to twelve washings using 50 ml hexane each time, to obtain an activated support-containing slurry.

To the activated support-containing slurry were added 2 ml of a 1:1 molar mixture of ethanol and 1-nonanol, and the slurry stirred for 3 hours at ambient temperature. 15 ml of TiCl₄ was then added, and the mixture stirred under reflux for 2 hours. After cooling down, the slurry was subjected to ten washing using 50 ml hexane each time and then dried.

Copolymerization

To a thoroughly cleaned 1 liter autoclave fitted with stirring and heating/cooling facilities and flushed with nitrogen, was added 350 g heptane and the temperature set at 85° C. A catalyst system, comprising 0.2 g of catalyst Al and 10 ml of a 10% solution of tri-ethyl aluminium in heptane, was added and reacted under stirring in the presence of 100 mg hydrogen for 5 minutes to activate the catalyst. Simultaneous glows of ethylene and 1-nonene at 10 and 7.5 g/min respectively were thereafter commenced. After 10 minutes the ethylene and 1-nonene feeds were stopped and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 0.75 mol % 1-nonene with melt flow index 0.25 dg/minute was 95 g. The polymer had the following properties:

| | |
|---|---|
| Tensile strength at yield | 15.25 MPa |
| Young's modulus | 675 MPa |
| Hardness | 53 |
| Izod Impact strength | 40.4 kJ/m² |
| Density | 0.9305 g/cc |

### EXAMPLE 4

To a thoroughly cleaned 1 liter autoclave fitted with stirring and heating/cooling facilities and flushed with nitrogen, was added 350 g heptane and the temperature set at 85° C. A catalyst system, comprising 0.2 g Catalyst B and 10 ml of a 10% solution of tri-ethyl aluminium in heptane, was added end reacted under stirring in the presence of 200 mg hydrogen for 5 minutes to activate the catalyst. Simultaneous flows of ethylene and 1-nonene at 10 and 10 g/min respectively were thereafter commenced. After 10 minutes the ethylene and 1-nonene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 1.3 mol % 1-nonene and with melt flow index 44 dg/minute was 151 g and the polymer had the following properties:

| | |
|---|---|
| Tensile strength at yield | 5.5 MPa |
| Young's modulus | 370 MPa |
| Hardness | 32 |
| Izod Impact strength | 21.5 kJ/m² |
| Density | 0.9232 g/cc |

### EXAMPLE 5

Catalyst B1 Preparation

In a 250 ml flask equipped with a reflux condenser and stirring facilities, 2 g of magnesium chloride with a total water content of 1.5% by mass was suspended in 60 ml highly purified hexane. 4 ml of isopentanol were added to the flask and the mixture was stirred for 3 hours under reflux. The mixture was allowed to cool to ambient temperature, and 10 g of tri-ethyl aluminium were added dropwise to avoid excessive hat build-up. The resultant slurry was allowed to cool to room temperature under stirring and then subjected to twelve washing using 50 ml hexane each time, to obtain an activated support-containing slurry.

To the activated support-containing slurry were added 2 ml of a 1:1 molar mixture of ethanol and 1-heptanol, and the slurry stirred for 3 hours at ambient temperature. 15 ml of TiCl₄ was then added, and the mixture stirred under reflux for 2 hours. After cooling down, the slurry was subjected to ten washing using 50 ml hexane each time and then dried.

Copolymerization

To a thoroughly cleaned 1 liter autoclave fitted with stirring and heating/cooling facilities and flushed with nitrogen, was added 350 g heptane and the temperature set at 85° C. A catalyst system, comprising 0.2 g catalyst B1 and 10 ml of a 10% solution of tri-ethyl aluminium in heptane, was added and reacted under stirring in the presence or 100 mg hydrogen for 5 minutes to activate the catalyst simultaneous flows of ethylene and 1-nonene at 10 and 8 g/min respectively were thereafter commenced. After 10 minutes the ethylene and 1-nonene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 1.1 mol % 1-nonene and with a melt flow index 2 dg/minute was 100 g. The polymer had the following properties:

| | |
|---|---|
| Tensile strength at yield | 10 MPa |
| Young's modulus | 440 MPa |
| Hardness | 44 |
| Izod Impact strength | 55.3 kJ/m² |
| Density | 0.925 g/cc |

### EXAMPLE 6

To a thoroughly cleaned 1 liter autoclave fitted with stirring and heating/cooling facilities and flushed with nitrogen, was added 350 g heptane and the temperature set at 80° C. A catalyst system, comprising 0.2 g of catalyst A and 10 ml of a 10% solution of tri-ethyl aluminium in heptane, was added and reacted under stirring in the presence of 100 mg hydrogen for 5 minutes to activate the catalyst. Simultaneous flows of ethylene and 1-heptene at 10 and 6 g/min respectively were thereafter commenced. After 10 minutes the ethylene and 1-heptene feeds were stopped, and the reaction continued for another 50 minutes. The reactor was depressurized and the catalyst deactivated by the addition of 100 ml iso propanol. The slurry was filtered and the polymer washed with acetone and dried under vacuum at 80° C. The yield at copolymer containing 1.7 mol % 1-heptane and with a melt flow index 15 dg/minute was 125 g. The polymer had the following properties.

| | |
|---|---|
| Tensile strength at yield | 9.22 MPa |
| Young's modulus | 483 MPa |
| Hardness | 42 |
| Izod Impact strength | 30.1 kJ/m² |
| Density | 0.921 g/cc |

### EXAMPLE 7

To a thoroughly cleaned 1 liter autoclave listed with stirring and heating/cooling facilities and flushed with nitrogen, was added 350 g heptane and the temperature set at 80° C. A catalyst system, comprising 0.2 g catalyst A and 10 ml of a 10% solution of tri-ethyl aluminium in heptane, was added and reacted under stirring in the presence of 100 mg hydrogen for 5 minutes to activate the catalyst. Simultaneous flows of ethylene and 1-heptene at 10 and 4 g min respectively were thereafter commenced. After 10 minutes the ethylene and 1-heptene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 1.3 mol % 1-heptene and with a melt flow index 18 dg/minute, was 125 g. The polymer had the following properties:

| | |
|---|---|
| Tensile strength at yield | 11.1 MPa |
| Young's modulus | 572 MPa |
| Hardness | 45 |
| Izod Impact strength | 20.7 kJ/m² |
| Density | 0.9261 g/cc |

### EXAMPLE 8

To a thoroughly cleaned 1 liter autoclave fitted with stirring and heating/cooling facilities and flushed with nitrogen, was added 350 g heptane and the temperature set at 80° C. A catalyst system, comprising 0.2 g of catalyst A and 100 mg a 10% solution of tri-ethyl aluminium in heptane, was added and reacted under stirring in the presence of 100 mg hydrogen for 5 minutes to activate the catalyst. Simultaneous flows of ethylene and 1-heptene at 10 and 2.5 g/min respectively were thereafter commenced. After 10 minutes the ethylene and 1-heptene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 0.7 mol % 1-heptene and with a melt flow index 17 dg/minute was 115 g. The polymer had the following properties:

| | |
|---|---|
| Tensile strength at yield | 14.5 MPa |
| Young's modulus | 675 MPa |
| Hardness | 53 |
| Izod Impact strength | 8.5 kJ/m² |
| Density | 0.9373 g/cc |

### EXAMPLE 9

To a thoroughly cleaned 1 liter autoclave fitted with stirring and heating/cooling facilities and flushed with nitrogen, was added 350 g heptane and the temperature set at 80° C. The catalyst system, comprising 0.2 g of catalyst A and 10 ml of a 10% solution of tri-ethyl aluminium in heptane, was added and reacted under stirring in the presence of 100 mg hydrogen for 5 minutes to activate the catalyst. Simultaneous flows of ethylene and 1-heptene at 10 and 1.5 g/min respectively were thereafter commenced. After 10 minutes the ethylene and 1-heptene feeds were stopped, and the reaction continued for another 50 minutes. The reactor was depressurized ad the catalyst deactivated by thy addition of 100 ml isopropanol. The slurry was filtered and the polymer washed with acetone and died under vacuum at 80° C. The yield of copolymer containing 0.45 ml 1-heptene and with a melt flow index 28 dg/minute was 115 g. The polymer had the following properties:

| | |
|---|---|
| Tensile strength at yield | 15.8 MPa |
| Young's modulus | 924 MPa |
| Hardness | 55 |
| Izod Impact strength | 7.4 kJ/m² |
| Density | 0.9420 g/cc |

### EXAMPLE 10

To a thoroughly cleaned 1 liter autoclave fitted with stirring and heating/cooling facilities ad flushed with nitrogen, was added 350 g heptane and the temperature set at 80° C. A catalyst system, comprising 0.29 of catalyst B and 10 ml of a 10% solution of tri-ethyl aluminium in heptane, was added and reacted under stirring in the presence of 100 mg hydrogen for 5 minutes to activate the catalyst. Simultaneous flows of ethylene and 1-heptene at 10 and 3 g/min respectively were thereafter commenced. After 10 minutes the ethylene and 1-heptene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 1.0% mol 1-heptene and with a melt flow index 48 dg/minute was 120 g. The polymer had the following properties:

| | |
|---|---|
| Tensile strength at yield | 13.2 MPa |
| Young's modulus | 605 MPa |
| Hardness | 50 |
| Izod Impact strength | 13 kJ/m³ |
| Density | 0.933 g/cc |

### EXAMPLE 11

Catalyst C Preparation

20 gm of partially anhydrized magnesium chloride with a water content of 1.5% by mass was stirred in 100 ml dibutyl ether at 80° C. for 30 minutes. 200 ml ethanol were added, and the excess solvent from the resulting solution were removed under reduced pressure until crystallization occurred. This fine crystalline material was washed three times with 100 ml heptane. This activated support was then dried under reduced pressure. To the activated support thus formed was added 150 ml TiCl₄ in 100 ml heptane. The mixture was heated to 80° C. and stirred for 60 minutes. This mixture was filtered while hot and washed with boiling heptane until no TiCl₄ could be detected in the washings. To the washed titanium containing compound was added 6 g (1:0.1 mg:Pathalate) of di-iso-butyl phthalate, heated to 80° C. and stirred for 60 minutes. It was then filtered while hot and washed five times with boiling heptane. To this washed compound was added 150 ml TiCl₄ in 100 ml heptane, heated to 80° C. and stirred for 60 minutes. The resultant catalyst was filtered while hot and washed with boiling heptane until no TiCl₄ could be detected in the washings, and then dried.

Copolymerization

To a thoroughly cleaned 1 liter autoclave fitted with stirring and heating/cooling facilities and flushed with nitrogen, was added 350 g heptane and the temperature set at 85° C. A catalyst system, comprising 10 ml of a 10% solution of tri-ethyl aluminium in heptane, 1.5 ml of a 7% solution of di-isopropyl dimethoxy silane in heptane and 0.3 g of catalyst C, was introduced in that order and reacted under stirring for 5 minutes to activate the catalyst Simultaneous flows of propylene and 1-nonene at 10 and 1.5 g/min respectively were thereafter commenced. After 10 minutes the propylene and 1-nonene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 0.9 mol % 1-nonene and with a melt flow index 2.3 dg/minute was 50 g. The polymer had the following properties:

| | |
|---|---|
| Tensile strength at yield: | 20.7 MPa |
| Young's modulus: | 937 MPa |
| Hardness: | 61 |
| Izod Impact strength: | 16 kJ/m² |

### EXAMPLE 12

To a thoroughly cleaned 1 liter autoclave fitted with stirring and heating/cooling facilities and flushed with nitrogen, was added 350 g heptane and the temperature set at 85° C. A catalyst system, comprising 10 ml of a 10% solution of tri-ethyl aluminium in heptane, 1.5 ml of a 7% solution of di-isopropyl dimethoxy silane in heptane and 0.3 g of catalyst C was introduced in that order and reacted under stirring for 5 minutes to activate the catalyst. Simultaneous flows of propylene and 1-nonene at 10 and 5 g/min respectively were thereafter commenced. After 10 minutes the propylene and 1-nonene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 1.0 mol % 1-nonene and with a melt flow index 3.3 dg/minute was 55 g. The polymer had the following properties:

| | |
|---|---|
| Tensile strength at yield: | 20.1 MPa |
| Young's modulus: | 800 MPa |
| Hardness: | 60 |
| Izod Impact strength: | 18 kJ/m² |

### EXAMPLE 13

To a thoroughly cleaned 1 liter autoclave fitted with stirring and heating/cooling facilities and flushed with nitrogen, was added 350 g heptane and the temperature set at 85° C. A catalyst system, comprising 10 ml of a 10% solution of tri-ethyl aluminium in heptane, 1.5 ml of a 7% solution of di-isopropyl dimethoxy silane in heptane and 0.3 g of catalyst C was introduced in that order and reacted under stirring for 5 minutes to activate the catalyst. Simultaneous flows of propylene and 1-nonene at 10 and 7.5 g/min respectively were thereafter commenced. After 10 minutes the propylene and 1-nonene feeds were stopped and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 1.5 mol % 1-nonene and with a melt flow index 2.2 dg/minute was 50 g. The polymer had the following properties:

Tensile strength at yield: 16.5 MPa

Young's modulus: 546 MPa

Hardness: 56

Izod Impact strength: 46.9 kJ/m²

### EXAMPLE 14

To a thoroughly cleaned 1 liter autoclave fitted with stirring and heating/cooling facilities and flushed with nitrogen was added 350 g heptane and the temperature set at 85° C. A catalyst system, comprising 10 ml of a 10% solution of tri-ethyl aluminium in heptane, 1.5 ml of a 7% solution of di-isopropyl dimethoxy silane in heptane and 0.3 g of catalyst C, was introduced in that order and reacted under stirring for 5 minutes to activate the catalyst. Simultaneous flows of propylene and 1-nonene at 10 and 1.2 g/min respectively were thereafter commenced. After 10 minutes the propylene and 1-nonene feeds were stopped and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 0.2 mol % 1-nonene and with a melt flow index 2.4 dg/minute was 70 g. The polymer had the following properties:

| | |
|---|---|
| Tensile strength at yield: | 24.2 MPa |
| Young's modulus: | 1014 MPa |
| Hardness: | 65 |
| Izod Impact strength: | 6.3 kJ/m² |

### EXAMPLE 15

To a thoroughly cleaned 1 liter autoclave fitted with stirring and heating/cooling facilities and flushed with nitrogen, was added 350 g heptane and the temperature set at 85° C. A catalyst system, comprising 10 ml of a 10% solution of tri-ethyl aluminium in heptane, 1.5 ml of a 7% solution of di-isopropyl dimethoxy silane in heptane and 0.3 g of catalyst C, was introduced in that order and reacted under stirring for 5 minutes to activate the catalyst. Simultaneous flows of propylene and 1-nonene at 10 and 6 g/min respectively were thereafter commenced. After 10 minutes the propylene and 1-nonene feeds were stopped and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 1.2 mol % 1-nonene and with a melt low index 0.4 dg/minute, was 50 g. The polymer had the following properties:

| | |
|---|---|
| Tensile strength at yield: | 19.5 MPa |
| Young's modulus: | 850 MPa |
| Hardness: | 57 |
| Izod Impact strength: | 29.5 kJ/m² |

### EXAMPLE 16

To a thoroughly cleaned 1 liter autoclave fitted with stirring and heating/cooling facilities and flushed with nitrogen was added 350 g heptane and the temperature set at 85° C. A catalyst system, comprising 10 ml of a 10% solution of tri-ethyl aluminium in heptane, 1.5 ml of a 7% solution of di-isopropyl dimethoxy silane in heptane and 0.3 g of catalyst C, was introduced in that order and reacted under stirring for 5 minutes to activate the catalyst. Simultaneous flows of propylene and 1-heptene at 10 and 1.6 g/min respectively were thereafter commenced. After 10 minutes the propylene and 1-heptene feeds were stopped, and the reaction continued for another 50 minutes. The reactor was depressurized and the catalyst deactivated by the addition of 100 ml isopropanol. The slurry was filtered and the polymer washed with acetone and dried under vacuum it 80° C. The yield of copolymer containing 0.4 mol % 1-heptene and with a melt flow index 11 dg/minute was 70 g. The polymer had the following properties:

| | |
|---|---|
| Tensile strength at yield: | 23.1 MPa |
| Young's modulus: | 885 MPa |
| Hardness: | 61 |
| Izod Impact strength: | 6 kJ/m² |

### EXAMPLE 17

To a thoroughly cleaned 1 liter autoclave fitted with stirring and heating/cooling facilities and flushed with nitrogen, was added 350 g heptane and the temperature met at 85° C., A catalyst system, comprising 10 ml of a 10% solution of tri-ethyl aluminium in heptane, 1.5 ml of a 7% solution of di-isopropyl dimethoxy silane in heptane and 0.3 g of catalyst C, was introduced in that order and reacted under stirring for 5 minutes to activate the catalyst. Simultaneous flows of propylene and 1-heptene at 10 and 2.5 g/min respectively were thereafter commenced. After 10 minutes the propylene and 1-heptene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 1.0 mol % 1-heptene and with a melt flow index 13 dg/minute was 75 g. The polymer had the following properties:

| | |
|---|---|
| Tensile strength at yield: | 18.2 MPa |
| Young's modulus: | 745 MPa |
| Hardness: | 58 |
| Izod Impact strength: | 10 kJ/cm² |

### EXAMPLE 18

To a thoroughly cleaned 1 liter autoclave fitted with stirring and heating/cooling facilities and flushed with nitrogen, was added 350 g heptane and the temperature set at 85° C. A catalyst system, comprising 10 ml of a 10% solution of tri-ethyl aluminium in heptane, 1.5 ml of a 1% solution di-isopropyl dimethoxy silane in heptane and 0.3 g of catalyst C, was introduced in that order and reacted under stirring for 5 minutes to activate the catalyst. Simultaneous flows of propylene and 1-heptene at 10 and 4 g/min respectively were thereafter commenced. After 10 minutes the propylene and 1-heptene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 1.4 mol % 1-heptene and with a melt flow index 10 dg/minute was 65 g. The polymer had the following properties:

| | |
|---|---|
| Tensile strength at yield: | 15.1 MPa |
| Young's modulus: | 546 MPa |
| Hardness: | 56 |
| Izod Impact strength: | 19 kJ/m² |

### EXAMPLE 19

To a thoroughly cleaned 1 liter autoclave fitted with stirring and heating/cooling facilities and flushed with nitrogen, was added 350 g heptane and the temperature set at 85° C. A catalyst system, comprising 10 ml of a 10% solution of tri-ethyl aluminium in heptane, 1.5 mg of a 7% solution of di-isopropyl dimethoxy silane in heptane and 0.3 g of catalyst C, was introduced in that order and reacted under stirring for 5 minutes to activate the catalyst, Simultaneous flows of propylene and 1-heptene at 10 and 6 g/min respectively were thereafter commenced. After 10 minutes the propylene and 1-heptene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 2 mol % 1-heptene and with a melt flow index 5 dg/minute was 65 g. The polymer had the following properties:

| | |
|---|---|
| Tensile strength at yield: | 12.6 MPa |
| Young's modulus: | 372 MPa |
| Hardness: | 50 |
| Izod Impact strength: | 46.5 kJ/m² |

### EXAMPLE 20

Catalyst D Preparation

Partially anhydrized magnesium chloride (20 g) was stirred in 100 ml dibutyl ether at 80° C. for 30 minutes. 200 ml ethanol were added, and the excess solvent from the resulting solution removed under reduced pressure until crystallization occurred. This fine crystalline material was washed three times with 10 ml heptane. This activated support was then dried under reduced pressure. To the activated support thus formed was added 6 g (1:0.1 mg:Phthalate) of di-iso-butyl phthalate. The mixture wag heated to 80° C. and stirred for 60 minutes. It was then filtered while hot and washed five times with boiling heptane. 150 ml TiCl₄ in 100 ml heptane was then added. The mixture was heated to 80° C. and stirred for 60 minutes. This mixture was filtered while hot and washed with boiling heptane until no TiCl₄ could be detected in the washings. To the washed titanium containing compound was added 6 g (1:0.1 mg:Phthalate) of di-iso-butyl phthalate. The mixture wag heated to 80° C. and stirred for 60 minutes. It was then filtered while hot and washed five times with boiling heptane, and then dried.

Copolymerization

To a thoroughly cleaned 1 liter autoclave fitted with stirring and heating/cooling facilities and flushed with nitrogen, was added 350 g heptane and the temperature set at 85° C. A catalyst system, comprising 10 ml of a 10% solution of tri-ethyl aluminium in heptane, 1.5 ml of a 7% solution of di-isopropyl dimethoxy silane in heptane and 0.3 g of catalyst D, was introduced in that order and reacted under stirring in the presence of 20 mg hydrogen for 5 minutes to activate the catalyst. Simultaneous flows of propylene and 1-heptene at 10 and 5 g/min respectively were thereafter commenced. After 10 minutes the propylene and 1-heptene feeds were stopped, and the reaction continued for another 50 minutes. The reactor was depressurized and the catalyst deactivated by the addition of 100 ml isopropanol. The slurry was filtered and the polymer washed with acetone and dried under vacuum at 80° C. The yield of copolymer containing 1.75 mol % 1-heptene and with a melt flow index 45 dg/minute was 70 g. The polymer had the following properties:

| | |
|---|---|
| Tensile strength at yield: | 13.5 MPa |
| Young's modulus: | 450 MPa |
| Hardness: | 53 |
| Izod Impact strength: | 19.8 kJ/m² |

1. A polymer obtained from ethylene and 1-heptane, with the molar proportion of ethylene to 1 heptene being from 98:2 to 99.8:0.2, and with the polymer having
a) a melt flow index as measured according to ASTM D1238, in the range of 0.01 to 50 dg/min; and
b) a density as measured according to ASTM D1505, in the range of 0.910 and 0.950 gm/cm³; and
c) an Izod notched impact strength, T, as measured according to ASTM D 256, which complies with the following equation:
I>10[C₇]
where [C₇] is the molar concentration of 1-heptene in the polymer; and/or
d) a tensile strength at yield, σ, as measured according to ASTM D 638 M, which complies with the following equation:
σ>−4.4[C₇]+17;
and/or
e) a modulus, E, as measured according to ASTM D 638 M, which complies with the following equation:
E>−275[C₇]+850;
and/or
f) a hardness, H, as measured according to ASTM D 2240, which complies with the following equations:
H>−10[C₇]+56

2. A polymer obtained from ethylene and 1-nonene, with the molar proportion of ethylene to 1-nonene being from 98.5:1.5 to 99.9:0.1, and with the polymer having
a) a melt flow index, as measured according to ASTM D1238, in the range 0.01 to 50 dg/min; and
b) a density as measured according to ASTM D1505, in the range of 0.910 to 0.950 gm/cm³, and
c) an Izod notched impact strength, I, as measured according to ASTM D 256, which complies with the following equation:
I>13.3[C₇]
where [C₉]is the molar concentration of 1-nonene in the polymer; and/or
d) a tensile strength at yield, σ, as measured according to ASTM D 638 M, which complies with the following equation:
σ>−16.67[C₉]+25;
and/or
e) a modulus, E, as measured according to ASTM D 638 M, which complies with the following equation:
E>−666.67[C₉]+1100;
and/or
f) a hardness, H, as measured according to ASTM D 2240, which complies with the following equations:
H>−30[C₉]+65

3. A polymer according to claim 1, which is that obtained by reacting the ethylene and the 1-heptene or 1-nonene in one or more reaction zones, while maintaining in the reaction zone(s) a pressure in the range between atmospheric and 200 kg/cm² and a temperature between patient and 300° C., in the presence of a Ziegler-Natta catalyst or catalyst system.

4. A polymer which comprises a polymerization product obtained by polymerizing, in the presence of a catalyst or a catalyst system comprising a catalyst and a cocatalyst, at least ethylene and 1-heptene or 1-nonene, with the molar proportion of ethylene to 1-heptene or 1-nonene in the polymer being from 90:10 to 93.9:1, and with the catalyst being a magnesium chloride supported titanium tetrachloride catalyst obtained by activating an anhydrous or partially anhydrized magnesium chloride support by (i) adding a complexing agent under inert conditions to a suspension of the magnesium chloride in an inert saturated hydrocarbon liquid, or to the magnesium chloride in powder form, with the complexing agent comprising a mixture of at least one branched alcohol having between 2 and 16 carbon atoms and at least one ether having between 8 and 16 carbon atoms, with sufficient of the complexing agent mixture being used so that the molar proportion of mixture to magnesium chloride is from 0.05:1 to 1.5:1, to obtain partially activated magnesium chloride; and (ii) adding an alkyl aluminium compound to the partially activated magnesium chloride, with sufficient alkyl aluminium compound being used so that the molar ratio of the alkyl aluminium compound to the magnesium chloride is from 1:1 to 6:1, thereby to obtain activated magnesium chloride; and loading the activated magnesium chloride with titanium chloride by (i) adding to the magnesium chloride a dicomponent alcohol mixture, with the molar ratio of the alcohol mixture to the initial magnesium chloride used being between 0.4:1 and 4:1, and (ii) adding titanium chloride to the magnesium chloride/alcohol mixture, with the molar ratio of titanium chloride to initial magnesium used being from 2:1 to 20:1.

5. A polymer obtained from propylene and 1-heptene, with the molar proportion of propylene to 1-heptene being from 98.0:2.0 to 99.0:0.2, and with the polymer having
a) a melt flow index as measured according to ASTM D1238, in the range 0.01 to 50 dg/min; and
b) an Izod notched impact strength, I, as measured according to ASTM D 256, which complies with the following equation:
I>7.5[C₇]
where [C₇] is the molar concentration of 1-heptene in the polymer; and/or
c) a tensile strength at yield, σ, as measured according to ASTM D 638 M, which complies with the following equation:
σ>−7[C₇]+24;
and/or
d) a modulus, E, as measured according to ASTM D 638 M, which complies with the following equation:
E>350[C₇]+1000;
and/or
e) a hardness, H, as measured according to ASTM D 2240, which complies with the following equation:
H>−7.2[C₇]+63

6. A polymer obtained from propylene and 1-nonene, with the molar proportion of propylene to 1-nonene being from 98.5:1.5 to 99.9:0.1, and with the polymer having
a) a melt flow index am measured according to ASTM D1238, in the range of 0.01 to 50 dg/min; and
b) an Izod notched impact strength, I, an measured according to ASTM D 256, which complies with the following equations:
I>15[C₉]
where [C₉] is the molar concentration of 1-nonene in the polymer; and/or
c) a tensile strength at yield, σ, as measured according to ASTM D 638 M, which complies with the following equation:
σ>−5.3[C₉]+24;
and/or
d) A modulus, E, as measured according to ASTM D 638 M, which complies with the following equation:
E>−333.3[C₉]+1000;
and/or
e) a hardness, H, as measured according to ASTM D 2240, which complies with the following equation:
H>−6.67[C₉]+65

7. A polymer according to claim 5, which is that obtained by reacting the propylene and the 1-heptene or 1-nonene in one or more reaction zones, while maintaining in the reaction zone(s) a pressure in the range between atmospheric and 200 kg/cm² and a temperature between ambient and 300° C., in the presence of a Ziegler-Natta catalyst or catalyst system.

8. A polymer which comprises a polymerization product obtained by polymerizing, in the presence of a catalyst or a catalyst system comprising a catalyst and a cocatalyst, at least propylene and 1-heptene or 1-nonene, with the molar proportion of propylene to 1-heptene or 1-nonene in the polymer being from 90:10 to 99.9:1, and with the catalyst being a magnesium chloride supported titanium tetrachloride catalyst obtained by activating an anhydrous or partially anhydrized magnesium chloride support by (i) adding a complexing agent under inert conditions to a suspension of the magnesium chloride in an inert saturated hydrocarbon liquid, or to the magnesium chloride in powder form, with the complexing agent comprising a mixture of at least one branched alcohol having between 2 and 16 carbon atoms and at least one ether having between 8 and 16 carbon atoms with sufficient of the complexing agent mixture being used so that the molar proportion of mixture to magnesium chloride is from 0.015:1 to 1.5:1: to obtain partially activated magnesium chloride, and (ii) adding an alkyl aluminium compound to the partially activated magnesium chloride, with sufficient alkyl aluminium compound being used so that the molar ratio of the alkyl aluminium compound to the magnesium chloride is from 1:1 to thereby to obtain activated magnesium chloride; and loading the activated magnesium chloride with titanium chloride by (i) adding a first ester component comprising an ester or a mixture of esters, to the activated magnesium chloride, with the molar ratio of the first ester component to the initial magnesium chloride used being between 0.05:1 and 5:1; (ii) thereafter adding titanium chloride to the magnesium chloride/ester mixture, with the molar ratio of titanium chloride to initial magnesium chloride used being from 2:1 to 20:1; and (iii) adding a second ester component comprising an ester or a mixture of esters to the titanium chloride containing magnesium chloride/ester mixture.

9. A polymer which comprises a polymerization product obtained by polymerizing, in the presence of a catalyst or a catalyst system comprising catalyst and a cocatalyst, at least propylene and 1-heptene or 1-nonene, with the molar proportion of propylene to 1-heptene or 1-nonene in the polymer being from en 90:10 to 99.9:1, and with the catalyst being a magnesium chloride supported titanium tetrachloride catalyst obtained by activating an anhydrous or partially anhydrized magnesium chloride support by (i) adding a completing agent under inert conditions to a suspension of the magnesium chloride in an inert saturated hydrocarbon liquid, or to the magnesium chloride in powder form, with the complexing agent comprising a mixture of at least one branched alcohol having between 2 and 16 carbon atoms and at least one ether having between 8 and 16 carbon atoms, with sufficient of the complexing agent mixture being used so that the molar proportion of mixture magnesium chloride is from 0.15:1 to 1.5:1, to obtain partially activated magnesium chloride, and (ii) adding an alkyl aluminium compound to the partially activated magnesium chloride, with sufficient alkyl aluminium compound being used so that the molar ratio of the alkyl aluminium compound to the magnesium chloride is from 1:1 to 6:1, thereby to obtain activated magnesium chloride; and loading the activated magnesium chloride with titanium chloride by (i) adding titanium chloride to the activated magnesium chloride, with the molar ratio of titanium chloride to initial magnesium chloride used being from 2:1 to 20:1; (ii) adding an eater component comprising an ester or a mixture of esters to the titanium containing magnesium chloride, with the molar ratio of the ester component to the initial magnesium chloride used being between 0.015:1 and 5:1; and (iii) adding titanium chloride to the titanium containing magnesium chloride/ester mixture, with the molar ratio of titanium chloride added in this step to the initial magnesium chloride used being from 2:1 to 20:1.

10. A process for producing a polymer, which process comprises reacting a reaction mixture comprising ethylene and 1-heptene or 1-nonene, in one or more reaction zones, while maintaining the reaction zone(s) at a pressure between atmospheric pressure and 200 kg/cm², and at a temperature between ambient and 300° C., in the presence of a catalyst or a catalyst system comprising a catalyst and a cocatalyst, such that the molar proportion of the ethylene to the 1-heptene or 1-nonene in the resultant polymer is from 90:10 to 99.9:0.1, with the catalyst being a magnesium chloride supported titanium tetrachloride catalyst obtained by activating an anhydrous or partially anhydrized magnesium chloride support by (i) adding a complexing agent under inert conditions to a suspension of the magnesium chloride in an inert saturated hydrocarbon liquid, or to the magnesium chloride in powder form, with the complexing agent comprising a mixture of at least one branched alcohol having between 2 and 16 carbon atoms and at least one ether having between 8 and 16 carbon atoms, with sufficient of the complexing agent mixture being used so that the molar proportion of mixture to magnesium chloride is from 0.05:1 to 1.5:1, to obtain partially activated magnesium chloride; and (ii) adding an alkyl aluminium compound to the partially activated magnesium chloride, with sufficient alkyl aluminium compound being used so that the molar ratio of the alkyl aluminium compound to the magnesium chloride is from 1:1 to 6:1, thereby to obtain activated magnesium chloride; and loading the activated magnesium chloride with titanium chloride by (i) adding to the magnesium chloride a dicomponent alcohol mixture with the molar ratio of the alcohol mixture to the initial magnesium chloride used being between 0.4:1 and 4:1, and (ii) adding titanium chloride to the magnesium chloride/alcohol mixture, with the molar ratio of titanium chloride to initial magnesium used being from 2:1 to 20:1.

11. A process for producing a polymer, which process comprises reacting a reaction mixture comprising propylene and 1-heptene or 1-nonene in one or more reaction zones, while maintaining the reaction zone(s) at a pressure between atmospheric pressure and 200 kg/cm², and at a temperature between ambient and 300° C., in the presence of a catalyst or a catalyst system comprising a catalyst and a cocatalyst, such that the molar proportion of the propylene to the 1-heptene or 1-nonene in the resultant polymer is from 90:10 to 99.0:0.1, with the catalyst being a magnesium chloride supported titanium tetrachloride catalyst obtained by activating an anhydrous or partially anhydrized magnesium chloride support by (i) adding a complexing agent under inert conditions to a suspension of the magnesium chloride in an inert saturated hydrocarbon liquid, or to the magnesium chloride in powder form, with the complexing agent comprising a mixture of at least one branched alcohol having between 2 and 16 carbon atoms and at least one ether having between 8 and 16 carbon atoms, with sufficient of the complexing agent mixture being used so that the molar proportion of mixture to magnesium chloride is from 0.015:1 to 1.5:1, to obtain partially activated magnesium chloride, and (ii) adding an alkyl aluminium compound to the partially activated magnesium chloride, with sufficient alkyl aluminium compound being used so that the molar ratio of the alkyl aluminium compound to the magnesium chloride is from 1:1 to 6:1, thereby to obtain activated magnesium chloride; and loading the activated magnesium chloride with titanium chloride by (i) adding a first ester component comprising an ester or a mixture of esters, to the activated magnesium chloride, with the molar ratio of the first ester component to the initial magnesium chloride used being between 0.05:1 and 5:1; (ii) thereafter adding titanium chloride to the magnesium chloride/ester mixture, with the molar ratio of titanium chloride to initial magnesium chloride used being from 2:1 to 20:1; and (iii) adding a second ester component comprising an ester or a mixture of esters to the titanium chloride containing magnesium chloride/ester mixture.

12. A process according to claim 11 wherein, in the production of the catalyst, the first ester component is the same as the second ester component.

13. A process according to claim 11, wherein, in the production of the catalyst, the first and second ester components are different.

14. A process for producing a polymer, which process comprises reacting a reaction mixture comprising propylene and 1-heptene or 1-nonene, in one or more reaction zones, while maintaining the reaction zone(s) at a pressure between atmospheric pressure and 200 kg/cm², and at a temperature between ambient and 300° C., in the presence of a catalyst system or a catalyst system comprising a catalyst and a cocatalyst, such that the molar proportion of the propylene to the 1-heptene or 1-nonene in the resultant polymer in from 90:10 to 99.1:0.1, with the catalyst being a magnesium chloride supported titanium tetrachloride catalyst obtained by activating an anhydrous or partially anhydrized magnesium chloride support by (i) adding a complexing agent under inert conditioning to a suspension of the magnesium chloride in an inert saturated hydrocarbon liquid, or to the magnesium chloride in powder form, with the complexing agent comprising a mixture of at least one branched alcohol having between 2 and 16 carbon atoms and at least one ether having between 8 and 16 carbon atoms, with sufficient of the complexing agent; mixture being used so that the molar proportion of mixture to magnesium chloride is from 0.015:1 to 1.5:1, to obtain partially activated magnesium chloride, and (ii) adding an alkyl aluminium compound to the partially activated magnesium chloride, with sufficient alkyl aluminium compound being used so that the molar ratio of the alkyl aluminium compound to the magnesium chloride is from 1:1 to 6:1, thereby to obtain activated magnesium chloride, and loading the activated magnesium chloride with titanium chloride by (i) adding titanium chloride to the activated magnesium chloride, with the molar ratio of titanium chloride to initial magnesium chloride used being from 2:1 to 20:1; (ii) adding an ester component comprising an ester or a mixture of esters to the titanium containing magnesium chloride, with the molar ratio of the ester component to the initial magnesium chloride used being between 0.015:1 and 5:1; and (iii) adding titanium chloride to the titanium containing magnesium chloride/ester mixture, with the molar ratio of titanium chloride added in the step to the initial magnesium chloride used being from 2:1 to 20:1.

15. A process according to claim 10, wherein a catalyst system is used, with the cocatalyst being an organo aluminium compound, and sufficient of the cocatalyst being used such that the atomic ratio of aluminium titanium in the catalyst system is from 0.1:1 to 500:1.

16. A polymer according to claim 2, which is that obtained by reacting the ethylene and the 1-heptene or 1-nonene in one or more reaction zones, while maintaining in the reaction zone(s) a pressure in the range between atmospheric and 200 kg/cm² and temperature between ambient and 300° C., in the presence of a Ziegler-Natta catalyst or catalyst system.

17. A polymer according to claim 6, which is that obtained by reacting the propylene and the 1-heptene or 1-nonene in one or more reaction zones, while maintaining in the reaction zone(s) a pressure in the range between atmospheric and 200 kg/cm² and a temperature between ambient and 300° C., in the presence of a Ziegler-Natta catalyst or catalyst system.

18. A process according to claim 11, wherein a catalyst system is used, with the cocatalyst being an organo aluminium compound, and sufficient of the cocatalyst being used such that the atomic ratio of aluminium to titanium in the catalyst system is from 0.1:1 to 500:1.

19. A process according to claim 14, wherein a catalyst system is used, with the cocatalyst being an organo aluminium compound, and sufficient of the cocatalyst being used such that the atomic ratio of aluminium to titanium in the catalyst system is from 0.1:1 to 500:1.
